(19) United States
(12) Patent Application Publication
(10) Pub. No.: US 2003/0173712 A1
(43) Pub. Date: Sep. 18, 2003

(54) Process for making artificial decorative masonry

(76) Inventor: Marcel Bergevin, Repentigny (CA)

Correspondence Address: INVENTARIUM, Suite 1607, 4050, Rosemont Blvd., Montreal, QC, H1X 1M4, CA

(21) Appl. No.: 10/378,782

(22) Filed: Mar. 3, 2003

Related U.S. Application Data
(60) Provisional application No. 60/360,620, filed on Mar. 4, 2002.

(51) Int. Cl. B28B 3/00

(52) U.S. Cl. 264/333; 52/315

(57) ABSTRACT

A method for making artificial masonry pieces wherein a portion of perlite is admixed with 7 portions of calcium sulfate (CaSO₄) and a resulting mixture is stirred; various pigments are added which are generally metal oxydes; the mixture is poured into molds and set to cure.

### BACKGROUND OF THE INVENTION

1. Field of the Invention

The invention relates generally to wall surfaces and most particularly to interior wall veneers that simulate bricks or natural stones.

2. Background of the Invention

Wall products for interiors, finished to reproduce the look of wood, brick or stone have been around for many years. They can be grouped into two groups: Firstly, wall panels, generally 4′×8′, with molded or simply printed representations of wood, brick, stone or other material. Secondly, wall products made of discrete components that are adhesively attached to a wall surface.

The prior art shows that various methods exist for making discrete artificial masonry pieces, molds and installation of the masonry on a surface, generally a wall.

Patents found in the prior art can be divided into three categories:

1) Those concerned with methods of laying precast or sectional components on surfaces such as in U.S. Pat. No. 3,690,076 by Harris and U.S. Pat. No. 4,727,698 by Altman for building fireplaces or U.S. Pat. No. 5,535,563 by Brown, which concerns itself with installing fitted manufactured stones to build decorative walls.

The second category concerns itself with making molds to create those artificial stones and bricks. A prime example of using molds is U.S. Pat. No. 5,637,236 by Lowe which discloses a method for producing wall, roadways, sidewalks and the like using cementitious material.

3) The third category is represented by U.S. Pat. No. 4,043,826 by Hum which discloses a process for making artificial rock.

This instant invention is mostly related to the prior art found in the second and third category. Generally, those products are designed with the handyman in mind and provide for a simple method of installation. Unfortunately, cutting masonry, whether real or cementitious is hard and requires special tools and skills. There is therefore a need for a masonry type product that provides discrete masonry pieces which are easy to cut with precision and install easily.

### SUMMARY OF THE INVENTION

It is a first object of this invention to provide a method for manufacturing masonry pieces that can easily be cut simply by making a score line.

It is a second object of this invention to disclose a method for installing discrete masonry pieces.

It is a third object of this invention to provide for a lightweight wall covering.

It is a final object of this invention to provide for a non-cementitious wall covering.

In order to do so, the present invention discloses a process for making artificial bricks and stones, hereinafter called masonry pieces and employs new methods and specific ingredients combined and admixed in order to create a final product that can be easily cut without the need of special masonry saw blades. In fact the pieces thus produced can be cut using an ordinary knife, event blunt instruments, in order to facilitate installation even by a lay person or to make installation much faster for skilled workers.

The foregoing and other objects, features, and advantages of this invention will become more readily apparent from the following detailed description of a preferred embodiment with reference to the accompanying drawings, wherein the preferred embodiment of the invention is shown and described, by way of examples. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE PREFERRED EMBODIMENT

no drawings

### DETAILED DESCRIPTION OF THE PREFERRED EMBODIMENT

The manufacturing method for the making of masonry pieces goes as follows:

Admix 1 portion of perlite with 7 portions of calcium sulfate (CaSO₄). Once admixed, the compound is stirred at low speed, approximately 60-100 RPM for about 10 minutes. During stirring, various pigments are added, they are generally metal oxydes, the amount and types of pigments added depends upon the final color desired.

Once the stirring is completed, the compound is put into a vacuum chamber in order to remove air bubbles trapped inside. The mixture is taken out of the vacuum chamber and poured into molds to cure. The preferred curing process is done at a temperature set at between 12C to 25C, preferably at 17% relative humidity and for about 4 hours.

Method of installation: Since the mansory pieces are mostly made out of calcium sulfate and are lightweight, many types of adhesives can be used, including a standard type 1 tile adhesive, to cover the surface upon which one desires to install the masonry pieces. The material upon which the adhesive is applied can be concrete, cinder blocks, gypsum boards, wood, melamine, which covers just about anything a wall can be made of. A wire mesh is not needed prior to the application of the adhesive.

The masonry pieces are applied to the wall. When a piece is too large for the place it is intended to be, it is cut by simply making a score line with a knife or any such hard object, even a blunt object like a screwdriver or a key. Once the score line is made, the piece can then be cracked, somewhat like cracking glass or ceramic.

To finish the job, the joints are filled with mortar as is normally done for ordinary brick or stone construction.

1. A method for making artificial masonry pieces wherein:
a portion of perlite is admixed with 7 portions of calcium sulfate (CaSO₄) and a resulting mixture is stirred;
various pigments are added which are generally metal oxydes;
the mixture is poured into molds and set to cure.

2. A method for making artificial masonry pieces as in claim 1 wherein:
the preferred curing process is done at a temperature set at between 12 C to 25 C.

3. A method for making artificial masonry pieces as in claim 1 wherein:
the preferred curing process is done at 17% relative humidity.

4. A method for making artificial masonry pieces as in claim 1 wherein:
the preferred curing duration is 4 hours.

5. A method for making artificial masonry pieces as in claim 1 wherein:
air bubble are extracted from the mixture after stirring is completed.

6. A method for making artificial masonry pieces wherein:
a portion of perlite is admixed with 7 portions of calcium sulfate (CaSO₄) and a resulting mixture is stirred at a speed, approximately 60-100 RPM;
the stirring takes approximately 10 minutes;
various pigments are added which are generally metal oxydes; the mixture is poured into molds and set to cure.

7. A method for making artificial masonry pieces as in claim 6 wherein:
the preferred curing process is done at a temperature set at between 12 C to 25 C.

8. A method for making artificial masonry pieces as in claim 6 wherein:
the preferred curing process is done at 17% relative humidity.

9. A method for making artificial masonry pieces as in claim 6 wherein:
the preferred curing duration is 4 hours.

10. A method for making artificial masonry pieces as in claim 6 wherein: after stirring is completed, air bubble are extracted from the mixture;

11. A method for installing artificial masonry pieces as described in claim 1 wherein:
an adhesive or otherwise bonding agent is applied onto a surface;
masonry pieces are applied to the surface;
the masonry pieces are cut by making a score line with a knife or any such hard objects and the piece is cracked much like glass or ceramic;
joints are filled with mortar as is normally done for ordinary brick or stone construction.

12. A method for installing artificial masonry pieces as described in claim 6 wherein:
an adhesive or otherwise bonding agent is applied onto a surface;
masonry pieces are applied to the surface;
the masonry pieces are cut by making a score line with a knife or any such hard objects and the piece is cracked much like glass or ceramic;
joints are filled with mortar as is normally done for ordinary brick or stone construction.
